(19) United States
(12) Patent Application Publication
(10) Pub. No.: US 2003/0172676 A1
(43) Pub. Date: Sep. 18, 2003

(54) Process of colouring of the glass materials

(76) Inventor: Sergei K. Evstropiev, St. Petersburg (RU)

Correspondence Address: CORNING INCORPORATED, SP-TI-3-1, CORNING, NY, 14831

(21) Appl. No.: 10/313,186

(22) Filed: Dec. 6, 2002

(30) Foreign Application Priority Data
Dec. 6, 2001 (WO) PCT/RU01/00535
Dec. 6, 2001 (WO) PCT/RU01/00536

(51) Int. Cl. C03C 21/00

(52) U.S. Cl. 65/30.13

(57) ABSTRACT

A process for colouring the glass materials to obtain decorated articles of glass-ceramics by the diffusion colouring technique, comprising the steps of: heat treatment of a precursor material or an article made of a transparent glass in vapours of a colourant selected from the group consisting of CuCl, CoCl₂, NiCl₂, MnCl₂, or their mixture, in the following controlled temperature-temporal mode: continuous or step-by-step, with isothermal holdings, heating to T=800-900° C. at rate of 300-500°C./h, and after the final isothermal holding—heating to 950-1150° C. at rate of 300-900° C./h, holding and cooling.

A process for colouring the glass materials to obtain decorated articles of glass by the diffusion colouring technique, comprising the steps of: heat treatment of a precursor material or an article made of a transparent glass in vapours of a colourant selected from the group consisting of CuCl, CoCl₂, NiCl₂, MnCl₂, or their mixture, in the following controlled temperature-temporal mode: continuous or step-by-step, with isothermal holdings, heating to 800-900° C. at rate of 250-700°C./h, and cooling after the final isothermal holding.

### BACKGROUND OF THE INVENTION

The invention relates to diffusion colouring of the articles made of glass materials for obtaining the decorated articles of glass and glass-ceramics.

The decoration processes that now are most widely used, are as follows: enamelling (e.g. patent of Germany 4241411, patent of France 2701473, U.S. Pat. No. 5,633,090); application of thin-film coatings from solutions or gas phase (PCT 93/25491, U.S. Pat. Nos. 3,694,299, 3,266,912); diffusion colouring of surface layers of glass and glass-ceramics (U.S. Pat. Nos. 3,313,644, 3,511,681, 3,528,847, 3,905,791, 3,967,040, 5,269,826, RU patents 1303572, 1528751).

These processes have the well-known advantages and drawbacks. Enamelling and application of thin-film coatings are the conventional and simple decoration processes that provide a broad colour gamut of coatings, provide the possibility to apply patterns, have a low cost and high productivity of fabrication process owing to the possibility of its high-level automatisation.

Nonetheless, after a coating or enamel have been applied on the glass surface, at the glass-coating interface a considerable gradient of properties may appear, which results in an essential deterioration of mechanical strength and heat-resistance of articles. Furthermore, in the course of enamelling the surface microrelief is altered, which may affect uniformity of the surface.

Presently one of the most promising processes for decoration of the glass and glass-ceramics articles is the process based on diffusion of colourants into the material surface layer.

Different processes and compositions for decoration are described in a number of patents and according to types of colourants can be divided into two groups regarding a degree of their diffusive mobility:

1. Copper, silver, gold, palladium, platinum, mercury, thallium that have a considerable diffusive mobility, and the colouring process using said materials is carried out at relatively low temperatures (500-800° C.).

2. Nickel, cobalt, iron, manganese, chromium that have lower diffusive mobility, and their use for colouring requires higher temperatures. The use of the first group of diffusion dyes is disclosed in the following patents.

According to U.S. Pat. No. 3,528,847, as the diffusion dye, compounds of copper, gold, silver, mercury, thallium (Ag₂S, Ag₂SO₄, AgNO₃, CuS, CuSO₄, CuCl) in the form of a paste, comprising a diluent (TiO₂, ZrO₂ and/or Al₂O₃), a plasticizer (bentonite, carbowax, lignin sulfonate), a humidifying agent (aliphatic alcohol and/or water) are used, and the process is carried out at 500-850° C. for 15-60 min.

According to U.S. Pat. No. 3,940,531, as a diffusion dye, used are compounds of platinum, silver, gold; a thinner—oil; the colouring paste must have viscosity of 5000 cP at 20° C.

According to U.S. Pat. No. 3,266,912, as the colourant, used are organic compounds of gold (gold dodecylmercaptide), platinum (platinum resinate) tantalum (tantalum resinate), niobium (niobium alcoholate) in a mixture with other organic compounds (toluene, hexamine), resins and other additives; the process temperature being 900-1350° C.

According to U.S. Pat. No. 3,511,681 used are both groups of ions-diffusants, such that in case of Cu, Ag, Au the process is carried out at 700° C. for 4 hours; in case of Co, Ni—8 hours.

According to the patents mentioned below, as the colourants, used are compounds of Ni, Co, Fe, etc., i.e. the components that exhibit a low diffusive mobility.

U.S. Pat. No. 3,313,644 describes a process for decorating the crystalline or semicrystalline articles, using a composition comprising at least one colourant selected from the group consisting of iron, cobalt, nickel and their compounds, at 900-1175° C. for 1-4 hours. A colourant can be used in the concentrated or diluted forms, in a mixture with inert powders that do not react with a polycrystalline article, such as TiO₂, Al₂O₃, MgO, ZnO, ZrO₂, SiO₂, etc. The application procedure can be implemented by sputtering, application by brush, silk screen printing.

U.S. Pat. No. 3,775,154 proposes a process, according to which, as the colourants, used are compounds of iron, manganese, nickel, vanadium, chromium, cobalt, titanium, with addition of 5-15% of silver compounds, 5-15% of elementary sulphur and 5-10% of a binder. The mixture is applied in the form of a thick paste.

According to USSR author's certificate 1303572, an article to be decorated is preliminarily treated in the melt of LiNO₃ at 300-350° C., and afterwards residuals of said melt are washed out, and the obtained article is treated by concentrated solution of salts (CuCl₂, CuSO₄, K₂CrO₄, K₂Cr₂O₇), and heat treatment is carried out at 530-680° C.

USSR author's certificate 1528751 proposes a composition for colouring the glass—solution of CuCl, KCr(SO₄)₂, K₂CrO₄ in water.

In all said decoration processes, the diffusion treatment of the article surface is done by melts or solutions of salts, or in the form of pastes.

In such decoration process, a predetermined or operative modification of, or control over the chemical composition of a colourant are difficult or virtually impossible (i.e. a possibility to modify the paste's or coating's chemical composition in the course of the diffusion colouring).

Besides, the direct contact of the surface with a colourant is accompanied by the process of baking-in of the paste onto the surface, which contributes to formation of asperities thereon and, consequently, affects its quality.

### SUMMARY OF THE INVENTION

The object of the invention consists in providing a possibility of operative adjustment of chemical composition of a colourant in the course of the colouring process itself, and excluding the baking-in process and formation of asperities on the decorated surface.

The above-specified objects are attained by the claimed process for colouring the glass materials, which process consists in that the treatment with a colourant, selected from the group consisting of CuCl, CoCl₂, NiCl₂, MnCl₂, or a mixture thereof, is carried out in vapours in accordance with the following controlled temperature-temporal mode:

continuous or step-by-step, with (1-8) isothermal holdings, heating to T=800-950° C. at rate of 250-700°C./h to obtain the glass articles or material.

For the purpose to produce the glass-ceramics articles or material, the process of formation of pyroceramics by heating to 1050-1090° C. at rate of 500-900° C., with subsequent cooling to the room temperature, is additionally carried out.

### BRIEF DESCRIPTION OF DRAWINGS

FIG. 1 illustrates . . .

FIG. 2 shows the transmission spectra of Kera White glass.

FIG. 3 shows the transmission spectrum of a sample of Kera White glass (thickness being 4 mm) after having been subjected to treatment of vapours of NiCl₂ for 24 hours at 1073° K.

### DETAILED DESCRIPTION OF THE INVENTION

The claimed process differs from all known processes based on the diffusion colouring technique in that a colourant is used not in the form of pastes or melts, but in the gaseous state.

Deposition of a dye from gaseous phase is widely used in case of the surface-decoration of glass materials, i.e. in case of application of film-coatings that determine the colour and appearance of the article surface (Bakhtik S., Pospihal V., Aesthetisation of Glass, Construction Literature publishers Moscow, 1970, pp. 214-235, 298-315).

Drawbacks of the surface-decoration, scilicet a low strength and insufficient heat-resistance are mentioned above.

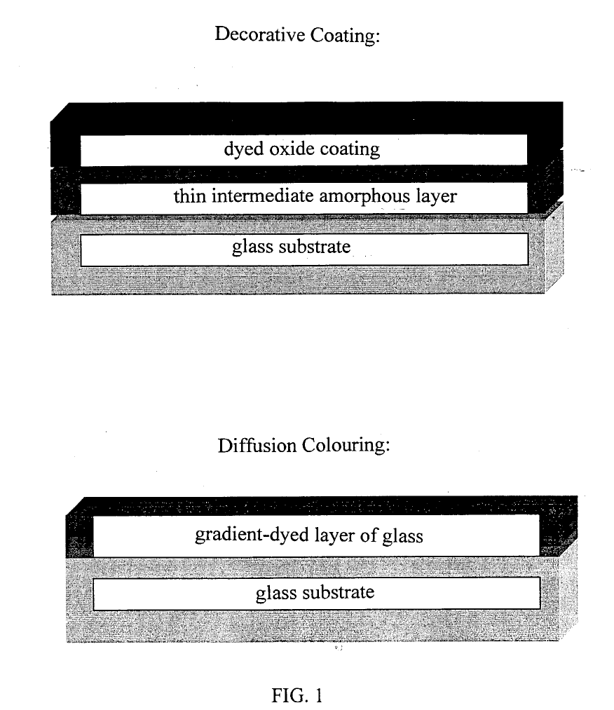

Processes of the surface colouring and the diffusion colouring are basically different: the former is directed to deposition of a dye onto the surface, the latter, by contrast, is directed to diffusion of a dye into depth of a material, while the surface deposition is not desirable (FIG. 1).

Thus, the outwardly similar technological operation—treatment by a dye in gaseous phase, gives utterly different results under different modes.

Known is the process of decoration of the bottle glass in vapours of CuCl (U.S. Pat. No. 3,502,454). However, according to teaching of said patent, decoration is done only for the articles made of the recoverable glass by heating to ˜500° C. within 2 hours, then to ˜600° C. at rate of ˜20° C./min.

Under such conditions, colouring of non-recoverable glass using the colourants other than CuCl is not possible.

Further, the prior art of colouring in vapours of CuCl does not predetermine with obviousness the use of vapours of other colourants in diffusion colouring not only due to a different temperature modality (different temperatures of formation of vapours). The cause of the process of diffusion of colourants from vapours into a material to be coloured is a difference of the chemical potentials of a colourant in a solid material to be coloured, on the one hand, and in gaseous phase, on the other hand. Forecast, calculation or even assessment of said difference is impossible, for the available references do not recite the thermodynamic characteristics of the precursor materials to be coloured and also similar materials that comprise the applicable coloured components.

And the matter of experimental definition of these characteristics is a separate difficult problem. Furthermore, in colouring of the glass-ceramics materials in the course of process: structure of a solid body itself is altered essentially and simultaneously with diffusion of a dye (nucleation and growth of crystals within a material). This circumstance causes further difficulties in determining the required thermodynamic characteristics.

But even a significant difference between the chemical potentials of colourants in gaseous phase and in a solid material to be coloured determine merely the thermodynamic possibility of the diffusion process. But rate of the diffusion process is further determined by diffusivity value of a colourant. Diffusivity values in vitreous and glass-crystalline materials bear strong relationship to a type of the diffusive ions [Yevstrop'yev K. K., Diffusions Processes in Glass, M., Stroy'izdat publishers, 1970, 168 pages; Svieriedov S. I., Diffusion and Kinetics of Interphase Interactions in Oxide Glasses, Abstract of doctoral theses for dr. of chem. sc. degree, S-Petersburg, 2000, 39 pages]. Numerous known experimental data recited in said references attest to the fact that diffusivity values of Cu⁺ ion are considerably higher than that of Co²⁺, Ni²⁺, Mn²⁺ ions proposed in the process developed by the applicant hereof.

For this reason, efficiency of the use of the latter for the diffusion colouring of the glass materials from gaseous phase is not a priori obvious at all.

Besides, the temperature-temporal modalities of decoration are novel and non-obvious.

Thus the claimed technical solution is not obvious from the prior art.

The claimed colouring process can be implemented in a number of embodiments.

For obtaining the coloured or decorated glass-ceramics, a precursor material or an article made of glass is heat-treated in vapours of a colourant selected from the group consisting of CoCl₂, NiCl₂, CuCl, MnCl₂, or their mixture, in the following temperature-temporal mode:

continuous or step-by-step, with 1-8 isothermal holdings, heating to 800-900° C. at rate of 350-500° C./h, and after the final isothermal holding—heating to 950-1150° C. at rate of 350-900° C./h. Then follows the step of cooling to the room temperature. According to this embodiment, the process of colouring and formation of pyroceramics takes place.

For obtaining the coloured or decorated articles or materials made of glass, the process is carried out in vapours of a colourant selected from the group consisting of CoCl₂; CuCl; NiCl₂; MnCl₂, or their mixture, in the following controlled temperature-temporal mode: continuous or step-by-step, with 1-8 isothermal holdings, heating to T=800-820° C. at rate of 300-500° C./h, the final isothermal holding being at least 2 hours, after which the cooling step is performed.

For obtaining the coloured or decorated articles, or materials made of glass-ceramics, the process is carried out in vapours of a colourant selected from the group consisting of CoCl₂; CuCl; NiCl₂; MnCl₂, or their mixture, in the following controlled temperature-temporal mode: continuous or step-by-step, with 1-8 isothermal holdings, heating to 800-900° C. at rate of 250-700° C./h, and after the final isothermal holding—temperature rise to 950-1150° C. at rate of 500-800° C./h, at that temperature duration of holding is 15-25 min.

For obtaining a bicolour decorative pattern: a protective coating to prevent diffusion of colourants from gaseous phase can be applied on a portion of the material surface.

Application of a multi-colour pattern can be implemented by a combined process, according to which process a pattern is applied at least by one dyeing paste that comprises at least one colourant used in the diffusion colouring with the use of pastes or solutions, for example—compounds of metals selected from the group consisting of Ni, Co, Cu, Ag, Mn, Fe, or their mixture. Oxides or halogenides are usually used as such compounds. In this case, a paste, in the course of heat-treatment, dyes the surface portion covered thereby with the colourants contained therein. At the same time, this paste also performs the function of the protective paste—prevents diffusion of another colourant from gaseous phase. In this case, it is recommended that the compounds of the metals different from the colourant contained in gaseous phase would be selected as the colourants.

The essence of the invention will be obvious in greater detail from the below-cited examples that do not limit its essence and serve to illustrate the claimed technical solution.

### EXAMPLE 1.

Colouring with the use of Cobalt Ions with Obtainment of Glass-ceramics

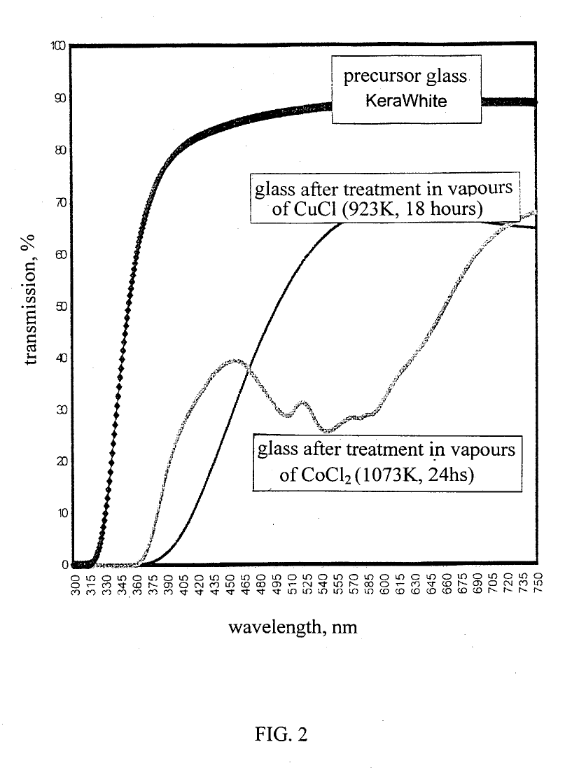

Specimens of a precursor transparent glass (Kera White) (FIG.2) were placed in a laboratory electric oven having dimensions of 600×500×300 mm and providing the interaction between the material surface and the air that contained vapours of CoCl₂. Specimens of the precursor glasses in the form of plates with dimensions of 90×40×10 mm, were positioned on a shelf. The glass specimens were further heat-treated in vapours of CoCl₂ (P_{CoCl2}=100 mm of merc. col. at 880° C.) in the following mode:

Temperature rise to 830° C. within 2 hours.

Holding at 830° C. for 17 minutes

Temperature rise from 830° C. to 1070° C. within 20 minutes.

Holding at 1070° C. for 20 minutes with further tempering of the glass-ceramics.

This treatment resulted in obtainment of glass-ceramics of dark blue colour, the surface of which glass-ceramics had no residuals of foreign substances, and had the same appearance as the surface of the glass-ceramics not subjected to colouring.

### EXAMPLE 2.

Colouring by Nickel Ions with Obtainment of Glass-ceramics

A specimen of a precursor transparent glass (Kera White) was placed in a laboratory electric oven that provided the interaction between the material surface and the air that contained vapours of NiCl₂. The glass specimen was further heat-treated in vapours of NiCl₂ (P_{NiCl2}=100 mm of merc. col. at 865° C.) in the mode that is identical to that of Example 1. The treatment resulted in obtainment of the glass-ceramics, wherein the surface, as a result of the treatment, acquired a purple-rosy tint.

### EXAMPLE 3.

Colouring by Copper Compounds with Obtainment of Glass-ceramics

A specimen of a precursor transparent glass (Kera White) was placed in a laboratory electric oven that provided interaction between the material surface and vapours of CuCl. The specimen was further heat-treated in vapours of CuCl in the mode that is identical to that of Example 1. The treatment resulted in obtainment of glass-ceramics, wherein the surface, as a result of the treatment, acquired a yellowish tint.

### EXAMPLE 4.

Colouring by Copper Ions with Obtainment of Glass

A specimen of a precursor transparent glass (Kera White) was placed in a laboratory electric oven that provided interaction between the material surface and vapours of CuCl. The specimen was further heat-treated in the following mode:

Temperature rise to 650° C. within 2 hours.

Holding at 650° C. for 18 hours and subsequent tempering of the glass.

The treatment resulted in obtainment of a transparent material, wherein the surface acquired a rosy-yellowish tint in the reflected colour. FIG. 2 illustrates the transmission spectrum of the specimen so coloured.

### EXAMPLE 5.

Colouring by Cobalt Ions with Obtainment of Glass

A specimen of a precursor transparent glass (Kera White) was placed in a laboratory electric oven that provided the interaction between the material surface and vapours of CoCl₂ (P_{CoCl2}=100 mm of merc. col. at 880° C.). The specimen was further heat-treated in the following mode:

Temperature rise to 800° C. within 2 hours.

Holding at 800° C. for 24 hours and subsequent tempering of glass.

The treatment resulted in obtainment of a transparent material, wherein the surface, as a result of the treatment, acquired a rosy-purple tint in the reflected colour. In the transmission spectra of the specimen so coloured, the absorption bands characteristic for Co²⁺ were observed (FIG. 2). As a result of this treatment, the material surface layer was coloured with Co ions.

### EXAMPLE 6.

Colouring by Nickel Ions with Obtainment of Glass-ceramics.

A specimen of a precursor transparent glass (Kera White) was placed in a laboratory electric oven that provided the interaction between the material surface and vapours of NiCl₂ (P_{NiCl}=100 mm of merc. col. at 865° C.). The specimen was further heat-treated in the following mode:

Temperature rise to 800° C. within 2 hours.

Holding at 800° C. for 24 hours and further tempering of glass.

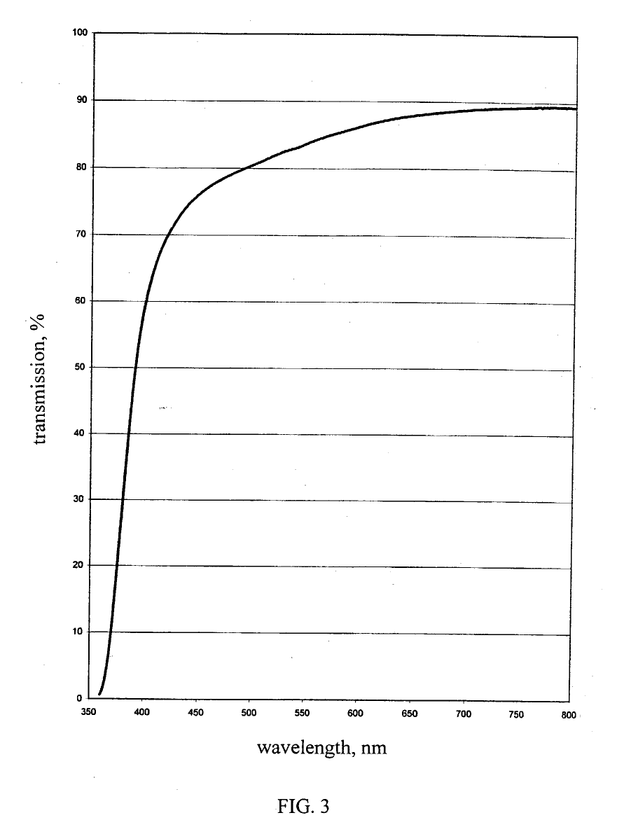

The treatment resulted in obtainment of a transparent material, wherein the surface, as a result of the treatment, acquired a purple-rosy tint in the reflected colour. FIG. 3 shows the transmission spectrum of the specimen so coloured.

### EXAMPLE 7.

Colouring by Manganese Ions with Obtainment of Glass-ceramics.

A specimen of a precursor transparent glass (Kera White) was placed in a laboratory electric oven that provided the interaction between the material surface and vapours of MnCl₂ (P_{MnCl2}=100 mm of merc. col. at 844° C.). The specimen was further heat-treated in the following mode:

Temperature rise to 830° C. within 2 hours.

Holding at 830° C. for 17 minutes

Temperature rise from 830° C. to 1070° C. within 20 minutes

Holding at 1070° C. for 20 minutes and subsequent tempering of glass-ceramics.

The treatment resulted in obtainment of transparent glass-ceramics, wherein the surface, as a result of the treatment, acquired a grayish-yellow tint.

### EXAMPLE 8.

Colouring with Application of a Protective Coating

A patterned protective coating was applied on the surface of a precursor transparent glass (Kera White). Then a specimen was placed in a laboratory electric oven, that provided interaction of the material surface with vapours of CoCl₂ (P_{CoCl2}=100 mm of merc. col. at 880° C.). The glass was further heat-treated in the following mode:

Temperature rise to 830° C. within 2 hours.

Holding at 830° C. for 17 minutes

Temperature rise from 830° C. to 1070° C. within 20 minutes

Holding at 1070° C. for 20 minutes and subsequent tempering of glass-ceramics and removal of the protective coating.

The treatment resulted in obtainment of glass-ceramics, on the surface of which glass-ceramics a pattern was formed (the surface regions, whereon CoCl₂ vapours acted, were coloured dark blue; and the regions that were under the protective coating, had white colour).

### EXAMPLE 9.

Colouring with Application of a Diffusion Coating.

A patterned diffusion coating that contained NiCl₂ was applied on the surface of a precursor transparent glass (Kera White). A specimen was then placed in a laboratory electric oven, that provided interaction of the material surface with vapours of CoCl₂ (P_{CoCl2}=100 mm of merc. col. at 880° C.). The glass was further heat-treated in vapours of CoCl₂ in the following mode:

Temperature rise to 830° C. within 2 hours.

Holding at 830° C. for 17 minutes

Temperature rise from 830° C. to 1070° C. within 20 minutes

Holding at 1070° C. for 20 minutes and subsequent tempering of glass-ceramics and removal of the protective coating.

The treatment resulted in obtainment of glass-ceramics, on the surface of which glass-ceramics, that had been coloured dark blue, a pattern of rosy-purple colour was formed (the surface regions, whereon vapours of CoCl₂ acted, were coloured dark blue; the regions that were beneath the diffusion coating, had rosy-purple colour).

1. A process for colouring the glass materials to obtain decorated articles of glass-ceramics by the diffusion colouring technique, comprising the steps of: heat treatment of a precursor material or an article made of a transparent glass in vapours of a colourant selected from the group consisting of CuCl, CoCl₂, NiCl₂, MnCl₂, or their mixture, in the following controlled temperature-temporal mode: continuous or step-by-step, with isothermal holdings, heating to T=800-900° C. at rate of 300-500° C./h, and after the final isothermal holding—heating to 950-1150° C. at rate of 300-900° C./h, holding and cooling.

2. A process for colouring the glass materials to obtain decorated articles of glass by the diffusion colouring technique, comprising the steps of: heat treatment of a precursor material or an article made of a transparent glass in vapours of a colourant selected from the group consisting of CuCl, CoCl₂, NiCl₂, MnCl₂, or their mixture, in the following controlled temperature-temporal mode: continuous or step-by-step, with isothermal holdings, heating to 800-900° C. at rate of 250-700° C./h, and cooling after the final isothermal holding.

3. The process as claimed in claims 1-2, characterized in that the temperature-temporal mode includes 1 to 8 isothermal holdings.

4. The process as claimed in any one of claims 1 to 3, characterized in that, for obtaining a decorative pattern, on a portion of the treated material surface applied is a coating that prevents diffusion of the colourants from gaseous phase.

5. The process as claimed in any one of claims 1 to 3, characterized in that, for obtaining a decorative pattern, said pattern is applied by a colouring composition that comprises oxides or chlorides of metals selected from the group consisting of Ni, Co, Mn, Ag, Fe.
